(19) United States
(12) Patent Application Publication
(10) Pub. No.: US 2007/0148607 A1
(43) Pub. Date: Jun. 28, 2007

(54) VERTICAL BOAT AND VERTICAL HEAT PROCESSING APPARATUS FOR SEMICONDUCTOR PROCESS

(76) Inventor: Yuichi TANI, Oshu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/612,710

(22) Filed: Dec. 19, 2006

(30) Foreign Application Priority Data
Dec. 28, 2005 (JP) 2005-378890
Oct. 18, 2006 (JP) 2006-283886

(51) Int. Cl. F27D 3/12

(52) U.S. Cl. 432/241

(57) ABSTRACT

A vertical boat for a semiconductor process is used for supporting target substrates during a heat process performed on the target substrates. The vertical boat includes struts fixed to a fixing member and arrayed at intervals in an annular direction, and fin portions formed on each of the struts at intervals in a vertical direction. Annular support plates are configured to respectively support the target substrates. Each of the annular support plates is held by corresponding fin portions of the struts located at the same height. Each of the annular support plates has an upper surface inclined inwardly downward with inclination set to agree with deformation of a corresponding one of the target substrates caused during the heat process, so that the upper surface comes into plane contact with a bottom of the target substrate during the heat process.

### CROSS-REFERENCE TO RELATED APPLICATIONS

This application is based upon and claims the benefit of priority from prior Japanese Patent Applications No. 2005-378890, filed Dec. 28, 2005; and No. 2006-283886, filed Oct. 18, 2006, the entire contents of both of which are incorporated herein by reference.

### BACKGROUND OF THE INVENTION

1. Field of the Invention

The present invention relates to a vertical boat and a vertical heat processing apparatus both for a semiconductor process for processing a target substrate, such as a semiconductor wafer. The term “semiconductor process” used herein includes various kinds of processes which are performed to manufacture a semiconductor device or a structure having wiring layers, electrodes, and the like to be connected to a semiconductor device, on a target substrate, such as a semiconductor wafer or a glass substrate used for an FPD (Flat Panel Display), e.g., an LCD (Liquid Crystal Display), by forming semiconductor layers, insulating layers, and conductive layers in predetermined patterns on the target substrate.

2. Description of the Related Art

In manufacturing semiconductor devices, various processing apparatuses are used to subject a target substrate, such as a semiconductor wafer, to processes, such as CVD (Chemical Vapor Deposition), oxidation, diffusion, reformation, annealing, and etching. As processing apparatuses of this kind, vertical heat processing apparatuses are known to subject a number of wafers together to a heat process. In general, vertical heat processing apparatuses have a vertical airtight reaction tube (process chamber) for accommodating wafers. The process chamber has a load port formed at the bottom, which is selectively opened and closed by a lid moved up and down by an elevator. Within the process chamber, the wafers are supported at intervals in the vertical direction on a holder called a wafer boat. A heating furnace is disposed around the process chamber.

In recent years, the diameter of semiconductor wafers becomes increasingly larger (e.g., a diameter of 300 mm). Accordingly, during a heat process, it is highly possible that wafers generate defects, such as slips (crystal defects), due to a stress caused by their own weight on a wafer boat (a vertical boat for heat-processing wafers). Further, during a heat process, the peripheral portion of each wafer differs from the central portion thereof in temperature change (the temperature of the peripheral portion can decrease faster), so the planar uniformity of a process tends to be deteriorated.

Jpn. Pat. Appln. KOKAI Publication No. 9-237781 (Patent Document 1) discloses, as a wafer boat, a ring-type boat structured to support the peripheral portion of each wafer by an annular support plate. According to this ring-type boat, the wafer can have a larger thermal capacity at the peripheral portion, so the temperature change is suppressed at the peripheral portion, and the temperature distribution can be thereby more uniform.

Jpn. Pat. Appln. KOKAI Publication No. 2002-231713 (Patent Document 2) discloses a ring-type boat having a modified structure. The technique disclosed in this document is based on an aspect in that the temperature distribution of a wafer becomes less uniform due to contact of the wafer with an annular support plate in a ring-type boat. Accordingly, the annular support plate is formed to have an upper surface inclined inwardly downward or outwardly downward, so that the wafer comes into line contact with the annular support plate.

Jpn. Pat. Appln. KOKAI Publication No. 2005-5379 (Patent Document 3) also discloses a ring-type boat having a modified structure. The technique disclosed in this document is based on an aspect in that a wafer suffers defects, such as scars and slips, due to contact of the wafer with an annular support plate in a ring-type boat. Accordingly, the annular support plate is formed to have an upper surface inclined inwardly downward, so that the wafer comes into line contact with the annular support plate.

### BRIEF SUMMARY OF THE INVENTION

An object of the present invention is provided with a vertical boat and a vertical heat processing apparatus both for a semiconductor process, which can prevent target substrates, such as semiconductor wafers, from generating defects, such as slips.

According to a first aspect of the present invention, there is provided a vertical boat for a semiconductor process, used for supporting a plurality of target substrates during a heat process performed on the target substrates, the boat comprising:

a fixing member;

a plurality of struts fixed to the fixing member and arrayed at intervals in an annular direction;

a plurality of fin portions formed on each of the struts at intervals in a vertical direction; and

a plurality of annular support plates configured to respectively support the target substrates, each of the annular support plates being held by a plurality of corresponding fin portions of the struts located at the same height,

wherein each of the annular support plate has an upper surface inclined inwardly downward with inclination set to agree with deformation of a corresponding one of the target substrates caused during the heat process, so that the upper surface comes into plane contact with a bottom of the corresponding one of the target substrates during the heat process.

According to a second aspect of the present invention, there is provided a vertical heat processing apparatus for a semiconductor process, used for performing a heat process on a plurality of target substrates together, the apparatus comprising:

a reaction chamber configured to accommodate the target substrates;

a heater configured to heat an interior of the reaction chamber;

a process gas supply system configured to supply a process gas into the reaction chamber;

an exhaust system configured to exhaust gas from the reaction chamber; and

a vertical boat for a semiconductor process configured to support the target substrates within the reaction chamber,

wherein the vertical boat comprises

a fixing member,

a plurality of struts fixed to the fixing member and arrayed at intervals in an annular direction,

a plurality of fin portions formed on each of the struts at intervals in a vertical direction, and

a plurality of annular support plates configured to respectively support the target substrates, each of the annular support plates being held by a plurality of corresponding fin portions of the struts located at the same height,

wherein each of the annular support plate has an upper surface inclined inwardly downward with inclination set to agree with deformation of a corresponding one of the target substrates caused during the heat process, so that the upper surface comes into plane contact with a bottom of the corresponding one of the target substrates during the heat process.

In the first and second aspects of the present invention, the annular support plate may be provided with a groove formed in the upper surface. The groove may be provided with a hole formed therein and penetrating the annular support plate in a thickness direction. The groove may be annular.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional side view schematically showing a vertical heat processing apparatus for a semiconductor process according to an embodiment of the present invention;

FIG. 2A is a plan view showing a vertical boat for heat-processing wafers, used in the apparatus shown in FIG. 1;

FIG. 2B is a sectional view of the vertical boat taken along a line IIB-IIB in FIG. 2A;

FIG. 3 is a partly sectional plan view showing a relationship between struts and a support plate in the vertical boat shown in FIGS. 2A and 2B;

FIG. 4 is a sectional view of the portion taken along a line IV-IV in FIG. 3;

FIG. 5A is a plan view showing the support plate shown in FIG. 3;

FIG. 5B is a sectional view of the portion taken along a line VB-VB in FIG. 5A;

FIG. 6A is a plan view showing a manner of measuring the inclination of a support plate;

FIG. 6B is a graph showing a result of measuring the inclination of a support plate;

FIG. 7 is a graph showing a result of measuring the inclination of another support plate;

FIG. 8A is a sectional view for explaining a wafer with problems due to a stress caused by its own weight in a vertical boat; and

FIG. 8B is a sectional view for explaining a wafer with problems due to thermal expansion in a vertical boat.

### DETAILED DESCRIPTION OF THE INVENTION

In the process of developing the present invention, the inventor studied issues concerning a vertical boat for heat-processing wafers used in vertical heat processing apparatuses. As a result, the inventor has arrived at the findings given below.

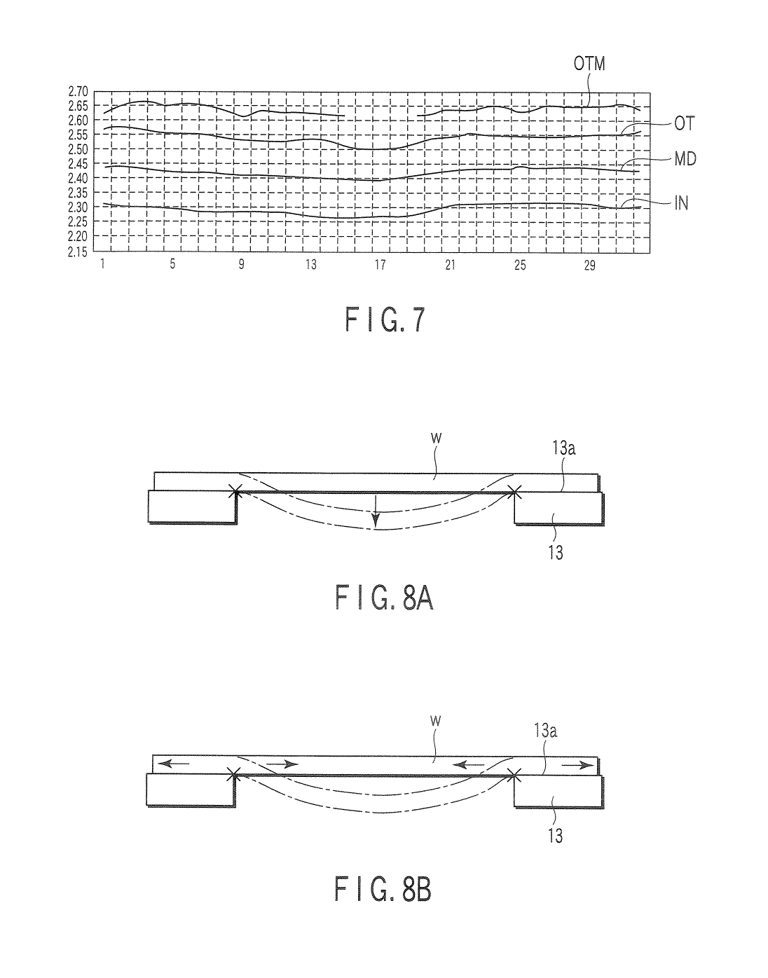

FIG. 8A is a sectional view for explaining a wafer with problems due to a stress caused by its own weight in a vertical boat. FIG. 8B is a sectional view for explaining a wafer with problems due to thermal expansion in a vertical boat. This vertical boat includes a support plate 13 with a horizontal upper surface 13a. When a wafer W is placed on the upper surface of the support plate 13, the central portion of the wafer W is bent downward due to a stress caused by its own weight, as shown in FIG. 8A. Consequently, stress concentration is caused, and defects, such as slips, are thereby easily generated or induced in the wafer W at a position (indicated by a symbol “X”) corresponding to the peripheral edge of the support plate 13. Further, as shown in FIG. 8B, also due to the thermal expansion, stress concentration is caused, and defects, such as slips, are thereby easily generated or induced in the wafer W at a position (indicated by a symbol “X”) corresponding to the peripheral edge of the support plate 13.

In light of these problems, conventional vertical boats are improved on the basis of a concept such that the contact area between a wafer and a support portion should be decreased to suppress generation of defects, such as scars and slips, and generation of particles. Actually, this technique can suppress generation of scars and particles due to contact but it brings about another problem. Specifically, during a heat process using a vertical boat, a wafer is warped due to a thermal stress, such as thermal expansion, as well as a stress caused by its own weight. Accordingly, stress concentration is caused, and generation sources of defects, such as slips, are thereby induced in the wafer at a position in contact with a support portion. Further, where an annular support plate is formed to have an upper surface inclined inwardly downward, so that a wafer comes into line contact with the support plate, as in the ring-type boat disclosed in Patent Documents 2 and 3 described above, stress concentration is caused at the edge of the wafer, and defects, such as slips, are thereby easily generated or induced.

An embodiment of the present invention achieved on the basis of the findings given above will now be described with reference to the accompanying drawings. In the following description, the constituent elements having substantially the same function and arrangement are denoted by the same reference numerals, and a repetitive description will be made only when necessary.

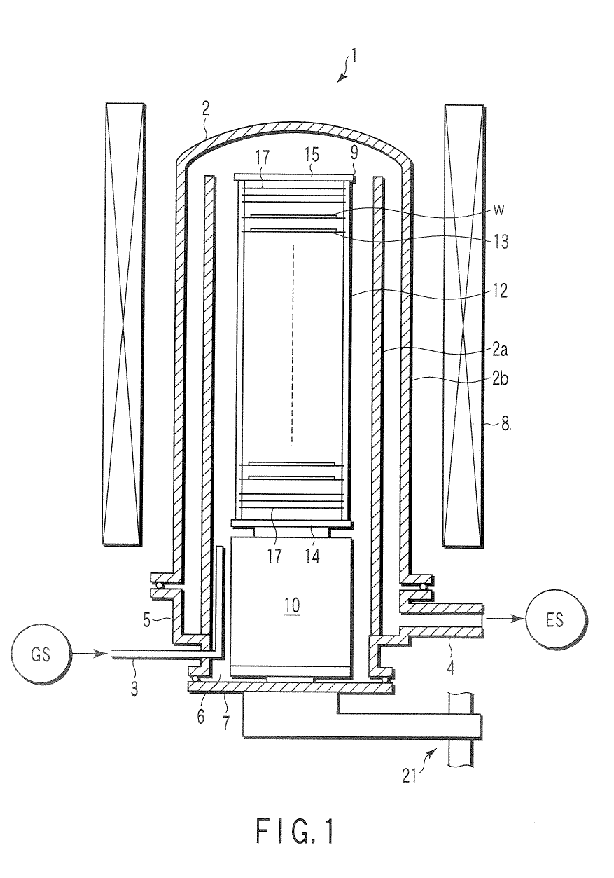

FIG. 1 is a sectional side view schematically showing a vertical heat processing apparatus for a semiconductor process according to an embodiment of the present invention. Referring to FIG. 1, this processing apparatus 1 is designed as a vertical heat-processing apparatus which forms a thin film on target substrates by CVD.

The processing apparatus 1 comprises a reaction tube (process chamber) 2 which is made of, e.g., quartz and accommodates a number of semiconductor wafers W serving as target substrates at intervals in the vertical direction. The reaction tube 2 has a double tube structure, including an inner tube 2a and an outer tube 2b, as shown in FIG. 1. However, the reaction tube 2 may have a single tube structure having only an outer tube. An annular manifold 5 is airtightly connected to the lower portion of the reaction tube 2. The manifold 5 is provided with a gas feed pipe (gas feed port) 3 to supply a process gas or an inactive gas (e.g., N₂) for purging into the reaction tube 2. The reaction tube 2 is provided with an exhaust pipe (exhaust port) 4 to exhaust the reaction tube 2.

The gas feed pipe 3 is connected to a supply line of a process gas supply system GS. The exhaust pipe 4 is connected to an exhaust line of a vacuum exhaust system ES having a vacuum pump and variable opening valve to vacuum-exhaust the interior of the reaction tube 2 and to control the pressure thereof. The manifold 5 is attached to a base plate (not shown). The reaction tube 2 is surrounded by a cylindrical heater 8 configured to heat and control the interior of the reaction tube 2 to a predetermined temperature of, e.g., about 300 to 1,200° C.

The manifold 5 present at the lower side of the reaction tube 2 forms a load port 6 of the heat processing furnace. A lid 7 for opening and closing the load port 6 is present below the reaction tube 2, and is configured to be moved up and down by an elevating mechanism 21. When the lid 7 comes into contact with the open end of the manifold 5, the load port 6 is airtightly closed.

A wafer holder or boat (a vertical boat for heat-processing wafers) 9 made of, e.g., quartz is mounted on the lid 7 via a heat insulating cylinder 10 serving as heat insulating means at the load port. The wafer boat 9 is structured to hold a number of, e.g., about 75 to 100 wafers W having a large diameter of, e.g., 300 mm in a horizontal state, at intervals in the vertical direction. The wafer boat 9 is loaded (transferred) into the reaction tube 2 by moving up the lid 7 by the elevating mechanism 21, and is unloaded (transferred) from the reaction tube 2 to a loading area on lower side by moving down the lid 7.

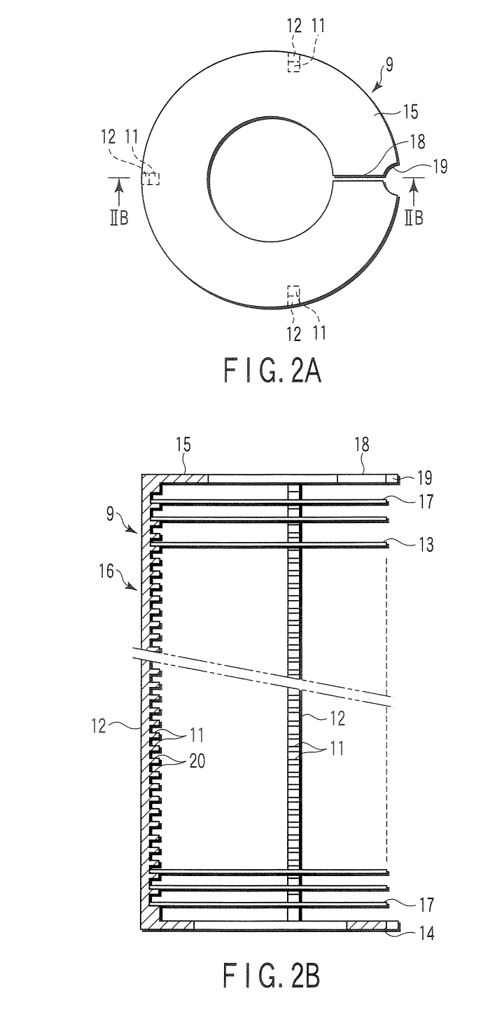

FIG. 2A is a plan view showing the wafer boat 9. FIG. 2B is a sectional view of the wafer boat 9 taken along a line IIB-IIB in FIG. 2A. The wafer boat 9 includes a boat body 16 used as a frame that is formed of a bottom plate 14, a top plate 15, and a plurality of, e.g., three, struts 12 fixed between these plates 14 and 15. The struts 12 are located at predetermined intervals in the annular direction to surround the wafers W supported thereon. The struts 12, bottom plate 14, and top plate 15 are integrally connected by, e.g., welding.

Each of the struts 12 is provided with fin portions 11 formed thereon at intervals in the vertical direction. Most of the fin portions 11 of the three struts 12 are arranged such that the corresponding three fin portions 11 present at the same height hold one annular support plate 13. Each of the support plates 13 is configured to support one wafer W in an essentially horizontal state. Further, a plurality of, e.g., 3 to 4, dummy plates 17 are held by fin portions 11 present on the lower side. Similarly, a plurality of, e.g., 3 to 4, dummy plates 17 are held by fin portions 11 present on the upper side. These dummy plates 17 are used to uniformize heat process conditions within the region where the support plates 13 are arrayed.

Where the wafer boat 9 is used at a heat process temperature within a mid- to high- temperature range of, e.g., 1,000° C. or less, the boat body 16, support plates 13, and dummy plates 17 may be made of quartz. On the other hand, where the boat 9 is used at a heat process temperature within a relatively higher temperature range of, e.g., 1,050 to 1,200° C., there members are preferably made of silicon carbide (SiC). In this case, in order to prevent the wafers W from being contaminated by low purity silicon carbide, the boat body 16, support plates 13, and dummy plates 17 are preferably coated with a protection film formed by, e.g., a CVD process after machining. The support plates 13 and dummy plates 17 have essentially the same outer contour.

The top plate 15 and bottom plate 14 have an annular shape. Where the boat 9 is used for a high temperature heat process, the top plate 15 is preferably provided with a slit 18 formed therein to release a thermal stress. In this embodiment, the top plate 15 and bottom plate 14 are further provided with a notch 19 formed in the periphery to avoid interference with a temperature detector of the bar type. In the boat body 16, the struts 12 are located at least at three positions on the right, left, and rear sides, so that the boat body 16 is opened at the front side. With this arrangement, the support plates 13 and dummy plates 17 can be attached to and detached from the boat body 16 through the front side, and wafers are transferred to and from the boat 9 through the front side. The rear side of the boat 9 may be provided with two struts 12 right and left, i.e., the total number of struts 12 may be four.

In order to stably hold the support plates 13 and dummy plates 17, the struts 12 on the right and left sides are slightly shifted toward the front side from the center line connecting the right and left sides. The horizontal fin portions 11 are formed at predetermined intervals on the inner side of each of these struts 12. For example, the fin portions 11 are formed by cutting the inner side of the struts 12 to form grooves 20, while using a rotary cutting blade inserted from the open side of the boat body 16. The fin portions 11 are preferably formed to be thin and small, so that the thermal capacity thereof is reduced to improve the planar uniformity in the temperature of the wafers W.

Since the space inside the boat body 16 is limited by the height of the vertical heat processing apparatus 1, it may be necessary to take a countermeasure to expand the region for supporting a predetermined number of wafers W. In this aspect, the fin portions 11 for holding the dummy plates 17 may be arrayed at intervals smaller than those of the fin portions 11 for holding the support plates 13.

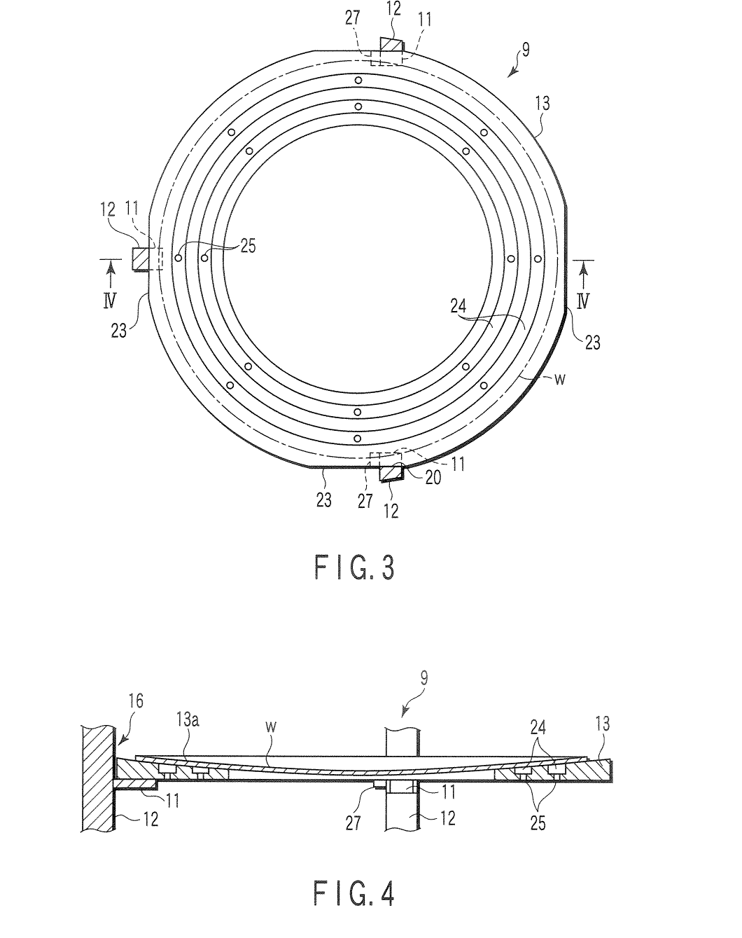

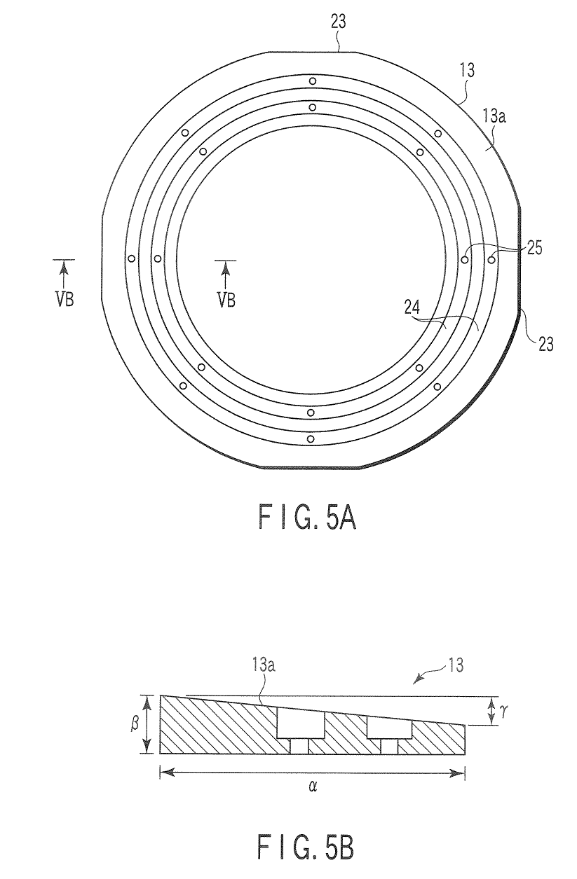

FIG. 3 is a partly sectional plan view showing a relationship between struts 12 and a support plate 13 in the wafer boat 9 shown in FIGS. 2A and 2B. FIG. 4 is a sectional view of the portion taken along a line IV-IV in FIG. 3. The bottom of the grooves 20 formed in the right and left struts 12 is set in parallel with the center line of the boat body 16 connecting the front and rear sides. The bottom of the grooves 20 formed in the rear strut 12 is set in parallel with the center line of the boat body 16 connecting the right and left sides. Each of the support plates 13 and dummy plates 17 is provided with notches 23 set in parallel with the bottoms of the grooves 20 of the right and left struts 12, and a notch 23 set in parallel with the bottom of the grooves 20 of the rear strut 12. With this arrangement, the support plates 13 and dummy plates 17 can be reliably and easily attached to the boat body 16.

The support plate 13 has an annular shape slightly larger than the outer diameter of the circular wafer W, so that the periphery of the flat bottom of the wafer W can be placed thereon. The upper surface (mount surface) 13a of the support plate 13 is formed to be inclined inwardly downward. This inclination is set to agree with deformation of the wafer W caused during the heat process, so that the upper surface 13a comes into plane contact with the flat bottom of the wafer W during the heat process. More specifically, in relation to the deformation of the wafer W having a large diameter, warp (bending) thereof due to its own weight and a thermal stress caused by the heat process is considered. In other words, the upper surface 13a is formed to have an inclination that attains support by plane contact with the bottom of the wafer W bent downward due to its own weight and a thermal stress. With this arrangement, the wafer W is prevented from suffering scars formed on the bottom, and/or defects, such as slips, generated or induced therein due to a thermal stress caused by the heat process and a stress caused by its own weight.

For a wafer W having a diameter of 300 mm, the support plate 13 is formed to have an outer diameter of 310 mm and an inner diameter of 200 mm. The width a between the outer edge and inner edge of the support plate 13 is 55 mm, and the thickness (height) β at the outer edge of the support plate 13 is 2 mm. Since the inclination angle of the upper surface (inclination surface) of the support plate 13 is too small to measure, the degree of this inclination is defined by measurement of an inclination height γ ([height at the outer edge]—[height at the inner edge]). According to this definition, the inclination height of the upper surface 13a of the support plate 13 is set to be 200 to 280 μm, and preferably to be 205 to 276 μm, as described later. The material of the support plate 13 can be selected from the group consisting of quartz, silicon, and silicon carbide.

The upper surface 13a of the support plate 13 is provided with grooves 24 and through holes 25 formed therein. With this arrangement, a wafer W is prevented from sticking to the upper surface (wafer mount surface) 13a of the support plate 13 during a heat process performed at a high temperature of, e.g., 1,050 to 1,200° C. In this embodiment, the upper surface 13a of the support plate 13 is provided with a plurality of, e.g., two, annular grooves 24 formed therein concentrically. Further, a plurality of through holes 25 are formed in the grooves 24 at predetermined intervals in the annular direction, and penetrate the support plate 13 in the vertical direction (the thickness direction). The support plate 13 is preferably provided with a plurality of grooves 24, but may be provided with only one groove 24. Further, each of the grooves 24 is preferably continuous in the annular direction, but may be discontinuous in the annular direction. Furthermore, the grooves 24 are preferably annular, but may be radial.

The support plate 13 is provided with stopper portions 27 that engage with the corresponding fin portions 11 of the right and left struts 12 to prevent the support plate 13 from sliding off. The stopper portions 27 extend downward from the right and left edge portions of the bottom of the support plate 13. The stopper portions 27 are respectively set in contact with and stopped by the rear sides of the fin portions 11 on the right and left sides. Consequently, the support plate 13 is prevented by the struts 12 from being shifted backward, rightward, and leftward. The stopper portion 27 is preferably formed to be thin and small, so that the thermal capacity thereof is reduced to improve the planar uniformity in the temperature of the wafer W.

As in the support plate 13, the dummy plate 17 is preferably provided with stopper portions that engage with the corresponding fin portions 11 of the right and left struts 12 to prevent the dummy plate 17 from sliding off. Further, where the dummy plate 17 is used for a heat process performed at a high temperature, the dummy plate 17 is preferably provided with a slit formed therein and extending forward from the center to release a thermal stress.

<Experiment>

In order to obtain an optimum inclination height of the upper surface 13a of the support plate 13, an experiment was performed, as follows. In this experiment, support plates 13 having different values of the inclination height were prepared, and the support plates 13 were used for performing a heat process in the vertical heat processing apparatus 1. As the wafer W, a P-type CZ (Czochralski) wafer doped with boron was used. Such wafers W were placed on the support plate 13 of the wafer boat 9, and an annealing process was performed at a temperature of 1,100° C. in the vertical heat processing apparatus 1. Then, the wafers W thus processed are observed by X-ray topography in terms of slip generation in the wafers W.

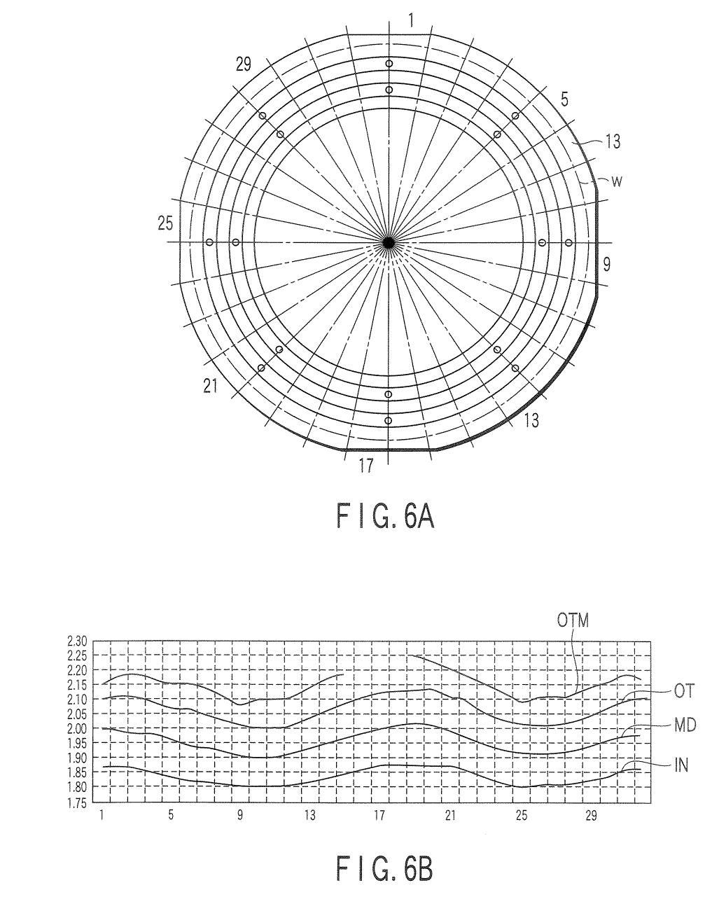

The inclination height γ of the upper surface (inclined surface) 13a of the support plate 13 was measured by a micrometer of the contact type. FIG. 6A is a plan view showing a manner of measuring the inclination of the support plate 13. As shown in FIG. 6A, the upper surface of the support plate 13 was divided into a plurality portions in the annular direction (e.g., 32 aliquots), and measurement was performed at these portions separately for the inner side (IN: inner periphery), middle side (MD), outer side (OT: outer periphery), and outermost side (OTM: outer edge).

By doing so, support plates 13 that did not generate slips in wafers were examined in terms of the inclination height γ. As a result, the support plates 13 that did not generate slips in wafers rendered results of three-dimensional measurement shown in FIGS. 6B and 7. FIG. 6B is a graph showing a result of measuring the inclination of a support plate having an inclination height γ within a range of 262 μm at the maximum and 205 μm at the minimum. FIG. 7 is a graph showing a result of measuring the inclination of another support plate having an inclination height γ within a range of 276 μm at the maximum and 227 μm at the minimum. In FIGS. 6B and 7, the horizontal axis denotes the position on the support plate 13 in the annular direction, and the vertical axis denotes the inclination height of the support plate. Further, in FIGS. 6B and 7, lines IN, MD, OT, and OTM denote measurement results obtained at portions of the support plate 13 on the inner side, middle side, outer side, and outermost side, respectively.

Judging from the results described above, the inclination height of the upper surface of a support plate is preferably set to be 205 to 276 μm. In light of manufacturing errors or tolerance limits, the inclination height is preferably set to be 200 to 280 μm. Further, in the examination on the inclination height γ of the support plate 13, the following results were obtained. Specifically, with a decrease in the inclination height (lower than 205 μm, and further lower than 200 μm), the probability of slip generation became higher in the portion of the wafer corresponding to the inner periphery of the support plate 13. On the other hand, with an increase in the inclination height (higher than 276 μm, and further higher than 280 μm), the probability of slip generation became higher in the outer peripheral portion of the wafer.

As described above, according to the wafer boat 9 used for a heat process and the vertical heat processing apparatus 1, the upper surface 13a of the annular support plate 13 of the boat 9 is formed to be inclined inwardly downward. This inclination is set to agree with deformation of the wafer W caused during the heat process, so that the upper surface 13a comes into plane contact with the flat bottom of the wafer W during the heat process. More specifically, in relation to the deformation of the wafer W having a large diameter, warp (bending) thereof due to its own weight and a thermal stress caused by the heat process is considered. In other words, the upper surface 13a is formed to have an inclination that attains support by plane contact with the bottom of the wafer W bent downward due to its own weight and a thermal stress. With this arrangement, the wafer W is prevented from suffering scars formed on the bottom, and/or defects, such as slips, generated or induced therein due to a thermal stress caused by the heat process and a stress caused by its own weight.

The inclination of the upper surface 13a of the support plate 13 can be expressed by the inclination height γ between the outer edge and inner edge of the support plate 13. Where a wafer W has a diameter of 300 mm, and the width α between the outer edge and inner edge of the support plate 13 is 55 mm, the inclination height γ is set to be 200 to 280 μm, and preferably to be 205 to 276 μm. With this arrangement, the wafer is effectively prevented from suffering defects, such as slips, generated or induced therein.

The upper surface 13a of the support plate 13 is provided with a plurality of annular grooves 24 formed therein concentrically. Further, through holes 25 are formed in the grooves 24 at predetermined intervals in the annular direction, and penetrate the support plate 13 in the vertical direction (the thickness direction). With this arrangement, an air layer can be formed between the wafer W and the upper surface 13a of the support plate 13, so that the wafer W is prevented from sticking to the support plate 13. Consequently, the wafer W is prevented from suffering defects, such as slips, generated or induced therein due to sticking of the wafer W during a heat process performed at a high temperature.

In the embodiment described above, the wafer boat 9 and vertical heat processing apparatus 1 are designed for wafers W having a diameter of 300 mm. Where the wafer boat 9 and vertical heat processing apparatus 1 are required to process wafers W having a larger diameter, they are preferably modified at the corresponding portions. For example, where a wafer W has a diameter of 450 mm, and the width a between the outer edge and inner edge of the support plate 13 is 55 mm, the inclination height γ is set to be 210 to 300 μm, and preferably to be 214 to 299.6 μm.

This value range can be obtained as follows. Specifically, where the diameter of a wafer W is changed from 300 mm to 450 mm, the diameter increases 1.5 times, the thickness is 1.07 times, the surface area is 2.25 times, the volume is 2.41 times, and the weight is 2.41 times. If the scale-up in the diameter of a wafer W from 300 mm to 450 mm is equivalent to the scale-up in the diameter from 200 mm to 300 mm, the effect of the scale-up on its own weight due to a thermal expansion amount increases 1.07 times. Accordingly, the inclination height γ is expressed by 1.07×(200 to 280 μm)=214 to 299.6 μm.

The ratio (1.07) of the thermal expansion amount can be obtained as follows. Specifically, it is assumed that the heat process temperature is 1,100° C., the average linear expansion coefficient of silicon (Si) is 4.02×10^{31 6}, and the thickness of a 300-mm diameter wafer is 0.775 mm. In this case, a thermal expansion amount caused in the thickness of the 300-mm diameter wafer is expressed by 0.775×(1,100³¹ 20)×4.023×10⁻⁶=0.00337 mm≅3.37 μm. On the other hand, the thickness of a 450-mm diameter wafer is 0.82925 mm. In this case, a thermal expansion amount caused in the thickness of the 450-mm diameter wafer is expressed by 0.82925×(1,100−20)×4.023×10⁻⁶=0.003603 mm≅3.602959 μm. Accordingly, the ratio of the thermal expansion amount of the 450-mm diameter wafer relative to the 300-mm diameter wafer is expressed by 3.602959/3.37=1.069127≅1.07.

Accordingly, where a wafer W has a diameter of 450 mm, and the width α between the outer edge and inner edge of the support plate 13 is 55 mm, the inclination height γ is set to be 210 to 300 μm, and preferably to be 214 to 299.6 μm. With this arrangement, the wafer is effectively prevented from suffering defects, such as slips, generated or induced therein.

The present invention is not limited to the embodiment described above, and it may be modified in various manners without departing from the general inventive concept of the present invention. For example, the upper surface of a support plate may be formed to attain support by plane contact with the essentially entire bottom of a wafer W. In this case, the upper surface is formed to be curved downward to correspond to the bottom of the wafer W bent downward due to a stress caused by its own weight and a thermal stress.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A vertical boat for a semiconductor process, used for supporting a plurality of target substrates during a heat process performed on the target substrates, the boat comprising:
a fixing member;
a plurality of struts fixed to the fixing member and arrayed at intervals in an annular direction;
a plurality of fin portions formed on each of the struts at intervals in a vertical direction; and
a plurality of annular support plates configured to respectively support the target substrates, each of the annular support plates being held by a plurality of corresponding fin portions of the struts located at the same height,
wherein each of the annular support plate has an upper surface inclined inwardly downward with inclination set to agree with deformation of a corresponding one of the target substrates caused during the heat process, so that the upper surface comes into plane contact with a bottom of the corresponding one of the target substrates during the heat process.

2. The boat according to claim 1, wherein the annular support plate is provided with a groove formed in the upper surface.

3. The boat according to claim 2, wherein the groove is provided with a hole formed therein and penetrating the annular support plate in a thickness direction.

4. The boat according to claim 2, wherein the groove is annular.

5. The boat according to claim 1, wherein the annular support plate consisting essentially of a material selected from the group consisting of quartz, silicon, and silicon carbide.

6. The boat according to claim 1, wherein the annular support plate is configured to support as the target substrate a semiconductor wafer having a flat bottom and a diameter of 300 mm, and the inclination of the upper surface is set such that height changes within a range of 200 to 280 μm in a distance of 55 mm.

7. The boat according to claim 1, wherein the annular support plate is configured to support as the target substrate a semiconductor wafer having a flat bottom and a diameter of 450 mm, and the inclination of the upper surface is set such that height changes within a range of 210 to 300 μm in a distance of 55 mm.

8. The boat according to claim 1, wherein the fixing member comprises a bottom plate and a top plate respectively located at a bottom and a top of the struts.

9. The boat according to claim 1, wherein the deformation of a corresponding one of the target substrates caused during the heat process comprises warp (bending) thereof due to its own weight and a thermal expansion.

10. The boat according to claim 1, wherein the heat process is set at a temperature of 1,050° C. to 1,200° C.

11. A vertical heat processing apparatus for a semiconductor process, used for performing a heat process on a plurality of target substrates together, the apparatus comprising:
a reaction chamber configured to accommodate the target substrates;
a heater configured to heat an interior of the reaction chamber;
a process gas supply system configured to supply a process gas into the reaction chamber;
an exhaust system configured to exhaust gas from the reaction chamber; and
a vertical boat for a semiconductor process configured to support the target substrates within the reaction chamber,
wherein the vertical boat comprises
a fixing member,
a plurality of struts fixed to the fixing member and arrayed at intervals in an annular direction,
a plurality of fin portions formed on each of the struts at intervals in a vertical direction, and
a plurality of annular support plates configured to respectively support the target substrates, each of the annular support plates being held by a plurality of corresponding fin portions of the struts located at the same height,
wherein each of the annular support plate has an upper surface inclined inwardly downward with inclination set to agree with deformation of a corresponding one of the target substrates caused during the heat process, so that the upper surface comes into plane contact with a bottom of the corresponding one of the target substrates during the heat process.

12. The apparatus according to claim 11, wherein the annular support plate is provided with a groove formed in the upper surface.

13. The apparatus according to claim 12, wherein the groove is provided with a hole formed therein and penetrating the annular support plate in a thickness direction.

14. The apparatus according to claim 12, wherein the groove is annular.

15. The apparatus according to claim 11, wherein the annular support plate consisting essentially of a material selected from the group consisting of quartz, silicon, and silicon carbide.

16. The apparatus according to claim 11, wherein the annular support plate is configured to support as the target substrate a semiconductor wafer having a flat bottom and a diameter of 300 mm, and the inclination of the upper surface is set such that height changes within a range of 200 to 280 μm in a distance of 55 mm.

17. The apparatus according to claim 11, wherein the annular support plate is configured to support as the target substrate a semiconductor wafer having a flat bottom and a diameter of 450 mm, and the inclination of the upper surface is set such that height changes within a range of 210 to 300 μm in a distance of 55 mm.

18. The apparatus according to claim 11, wherein the fixing member comprises a bottom plate and a top plate respectively located at a bottom and a top of the struts.

19. The apparatus according to claim 11, wherein the deformation of a corresponding one of the target substrates caused during the heat process comprises warp (bending) thereof due to its own weight and a thermal expansion.

20. The apparatus according to claim 11, wherein the heat process is set at a temperature of 1,050° C. to 1,200° C.
